(19) United States
(12) Patent Application Publication
(10) Pub. No.: US 2003/0151367 A1
(43) Pub. Date: Aug. 14, 2003

(54) Cold cathode and method for operating the same

(75) Inventors: Toru Kawase, Katano-shi (JP); Keisuke Koga, Kyoto (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/366,152

(22) Filed: Feb. 13, 2003

(30) Foreign Application Priority Data
Feb. 13, 2002 (JP) 2002-35825

(51) Int. Cl. H01J 25/50

(52) U.S. Cl. 315/39.57; 315/94; 315/261; 315/168

(57) ABSTRACT

A method is applied for operating a cold cathode having at least one electron emission portion and a control electrode for controlling an emission of electrons, in which an electron beam is extracted out of the cold cathode by applying operating voltages to the electron emission portion and the control electrode, respectively. At least one auxiliary electron emission portion is provided other than the electron emission portion positioned at an operating position for emitting electrons. In order to replace the electron emission portion to be operated, the electron emission portions are moved so that the auxiliary electron emission portion is positioned at the operating position.

### FIELD OF THE INVENTION

The present invention relates to an electric field emission type cold cathode and a method for operating the same, and particularly it relates to a cold cathode having an electron emission portion suitable for the life prolongation and a method for operating the same.

### BACKGROUND OF THE INVENTION

An electric field emission type cold cathode is expected to be applied to an image display apparatus such as a cathode ray tube (CRT), etc. used for a color TV or a high-definition monitor TV, an electron gun used for an electron microscope, or an electron beam exposure device using converged electron beams, etc. In order to apply the cold cathode to the above-mentioned apparatuses, etc., technologies for the life prolongation are required, and various research has been reported.

An electron emission portion of a conventional electron emission type cold cathode device deteriorates after it is operated for a long time, resulting in the reduction of the amount of emission current. Conventionally, since only one electron emission portion, that is emitter region, is provided for the cold cathode, the life of the cold cathode is terminated when the emitter region deteriorates to a certain level. Therefore, under the present situation, a cold cathode has a shorter life than that of a thermal cathode used for an electron gun.

As one of various means considered for the life prolongation, a cold cathode device disclosed in JP 5 (1993)-12986A, etc. is shown in FIG. 13.

In FIG. 13, reference numeral 104 denotes an insulating substrate. On the insulating substrate 104, electrodes 101 and 102 and a particulate film 103 including an electron emission material are formed. Reference numeral 105 denotes an electron emission portion; 108 denotes a conductive member; 106 denotes a phosphor target including a transparent plate, a transparent electrode and a phosphor; and 107 denotes an electron irradiation region (a light emitting portion). As shown herein, plural electron emission portions 105 (in FIG. 13, two electron emission portions) are disposed and electrically connected in series to form one electron emission device (unit device). In the vicinity of the electron emission portions 105, the conductive members 108 are disposed in electrical contact with at least one of the electrodes 101, 102 provided on both sides of the electron emission portions 105. With this configuration, although the principle is not dear, electrons are emitted from either one of the electron emission portions 105.

In this configuration, in order to replace the electron emission portion 105 to be operated with the other electron emission portion 105, the conductive member 108 is melted by heat supplied by irradiation with infrared rays, thus short-circuiting the electron emission portion 105 that is not to be operated and allowing the other electron emission portion 105 to contribute to electron emission. The infrared ray used at the time may be a laser, etc. as a heat source, which preferably has a wavelength matched to the absorption wavelength of the conductive member 108.

In the cold cathode device having such a configuration, by using only irradiation with infrared rays as a heat source from the outside, it is possible to replace the electron emission portion 105 contributing to emission of electrons, easily. Thus, for example, the following effects: (1) to (3), etc. can be expected. (1) It is possible to manufacture devices having less distribution in the characteristics. (2) The yield on manufacture of the electron emission portion is improved. (3) The life of the electron emission portion is improved.

However, in the prior art shown in FIG. 13, when one electron emission portion 105 is replaced, the heat source has to be irradiated from the outside, so that the workability is not good. Furthermore, there is also a problem in that when there are many portions being replaced, a cycle time is increased, thereby reducing the productivity. Furthermore, in order to locate a defective part in the electron emission portion 105, a device such as a microscope is required, thus deteriorating the practicality and mass productivity.

Furthermore, since the electron emission portions 105 are connected in series, in a case where a control electrode having hole is provided above them, the position for emitting electron beam is shifted with respect to the hole of the electron emission portions 105 being replaced. Therefore, the position of the electron beams is displaced with respect to the electric field by the control electrode, thus deteriorating the focus property.

Furthermore, since work from the outside is required in order to replace one electron emission portion 105, the electron emission portion 105 actually can be changed only in the manufacturing process. In other words, if a problem occurs in the election emission portion after a product using this comes on the market, the defective electron emission portion cannot be replaced. Consequently, it has not been effective for prolonging the life of the device.

### SUMMARY OF THE INVENTION

It is an object of the present invention to provide a cold cathode capable of changing a cathode with high accuracy without axis misalignment of an electron beam and prolonging the life of the cathode while maintaining the focus property of the electron beams.

According to the present invention, a method is applied for operating a cold cathode having at least one electron emission portion and a control electrode for controlling an emission of electrons, in which an electron beam is extracted out of the cold cathode by applying operating voltages to the electron emission portion and the control electrode, respectively. At least one auxiliary electron emission portion is provided other than the electron emission portion positioned at an operating position for emitting electrons, and in order to replace the electron emission portion to be operated, the electron emission portions are moved so that the auxiliary electron emission portion is positioned at the operating position.

It is preferable that plural sets of the electron emission portions are disposed on a cathode member, the control electrode has through holes which are capable of facing selectively one of the sets of the electron emission portions, so that the electron beams are extracted through the through holes, and in order to replace the set of the electron emission portions to be operated, the cathode member is moved so as to change the relative positional relationship with the control electrode. Thus, a selected auxiliary set of the electron emission portions is positioned to face the through holes.

Each of the electron emission portions and the through holes may have a circular shape, and the cathode member may be moved so as to adjust the relative positional relationship with the control electrode, whereby the centers of the electron emission portions of the selected auxiliary set are allowed to coincide with the center axes of the through holes.

The electron emission portions or the cathode member may be moved by a magnetic force.

It is preferable that the electron emission portions are retained at the operating position by using a mechanism for preventing movement of the electron emission portions or the cathode member backward from the operating position.

Another method of the present invention also is applied for operating a cold cathode having at least one electron emission portion and a control electrode for controlling an emission of electrons, in which an electron beam is extracted out of the cold cathode by applying operating voltages to the electron emission portion and the control electrode, respectively. A plurality of the electron emission portions are disposed axially symmetrically with respect to a center of an operating position for emitting electrons, and in order to replace the electron emission portion to be operated, the electron emission portion to be supplied with the operating voltage is changed to the replacing electron emission portion.

In this configuration, the electron emission portions may be provided in shapes obtained by dividing a disk-shaped area concentrically or radially.

A cold cathode according to the present invention includes: at least one electron emission portion; and a control electrode for controlling an emission of electrons, in which an electron beam is extracted out of the cold cathode by applying operating voltages to the electron emission portion and the control electrode, respectively. At least one auxiliary electron emission portion is provided other than the electron emission portion positioned at an operating position for emitting electrons, and a replacing mechanism is provided in order to replace the electron emission portion to be operated, the replacing mechanism being capable of moving the electron emission portions so that the auxiliary electron emission portion is positioned at the operating position.

It is preferable that plural sets of the electron emission portions are disposed on a cathode member, the control electrode has through holes which are capable of facing selectively one of the sets of the electron emission portions, so that the electron beams are extracted through the through holes, and the replacing mechanism is provided in order to replace the set of the electron emission portions to be operated. The replacing mechanism is capable of moving the cathode member so as to change the relative positional relationship with the control electrode, whereby a selected auxiliary set of the electron emission portions is positioned to face the through holes.

In this configuration, each of the electron emission portions and the through holes may have a circular shape, and the cathode member may be moved so as to adjust the relative positional relationship with the control electrode, whereby the centers of the electron emission portions of the selected auxiliary set are allowed to coincide with the center axes of the through holes.

The replacing mechanism may move the electron emission portions or the cathode member by a magnetic force.

The cold cathode further may include a mechanism for preventing movement of the electron emission portions or the cathode member backward from the operating position so that the electron emission portions are retained at the operating position.

Another cold cathode of the invention includes at least one electron emission portion, and a control electrode for controlling an emission of electrons, in which an electron beam is extracted out of the cold cathode by applying operating voltages to the electron emission portion and the control electrode, respectively. A plurality of the electron emission portions are disposed axially symmetrically with respect to a center of an operating position for emitting electrons, and a replacing mechanism is provided in order to replace the electron emission portion to be operated, the replacing mechanism being capable of changing the electron emission portion to be supplied with the operating voltage to the replacing electron emission portion.

In this configuration, the electron emission portions may be provided in shapes obtained by dividing a disk-shaped area concentrically or radially.

The above-described cold cathode may further includes a current control device connected to an emitter constituting the electron emission portion.

According to the method for operating a cold cathode, or the cold cathode mentioned above, it is possible to replace an electron emission portion without the axis misalignment of an electron beam. Therefore, it is possible to prolong the life of the cathode while maintaining the focus property of the beam. Therefore, it is possible to achieve electron beams capable of prolonging the life with high brightness and high resolution.

### BRIEF DESCRIPTION OF THE DRAWINGS

FIG. 1 is a perspective view showing a schematic configuration of a cold cathode according to a first embodiment of the present invention.

FIGS. 2A and 2B are plan views showing a more specific structure and operation of the cold cathode of FIG. 1.

FIGS. 3A and 3B are plan views showing a further specific structure and operation of the cold cathode of FIG. 1.

FIGS. 4A and 4B are plan views showing a specific structure and operation of a part of the cold cathode of FIG. 1.

FIGS. 5A and 5B are plan views showing a specific structure and operation of another part of the cold cathode of FIG. 1.

FIG. 6 is a schematic plan view showing a modified example of a cold cathode according to the first embodiment of the present invention.

FIG. 7 is a schematic plan view showing a cold cathode according to a second embodiment of the present invention.

FIG. 8 is a schematic cross-sectional view showing a cold cathode according to the second embodiment of the present invention.

FIG. 9 is a schematic plan view showing a cold cathode according to a third embodiment of the present invention.

FIG. 10 is a schematic cross-sectional view showing an operating circuit of a cold cathode according to a fourth embodiment of the present invention.

FIG. 11 is a schematic view showing an operating state of a cold cathode according to the fourth embodiment of the present invention.

FIG. 12 is a schematic cross-sectional view showing an application example of a cold cathode according to a fifth embodiment of the present invention.

FIG. 13 is a schematic respective view showing a conventional example of a cold cathode device.

### DESCRIPTION OF THE PREFERRED EMBODIMENTS

(First Embodiment)

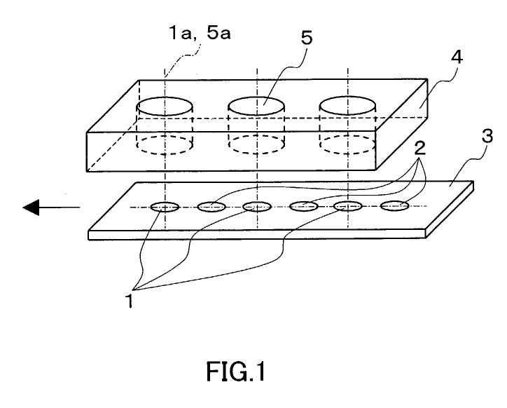

Hereinafter, a structure of a cold cathode according to the first embodiment of the present invention and a method for changing thereof will be explained with reference to FIGS. 1 to 5.

FIG. 1 schematically shows a cathode member 3 and a control electrode 4, which constitute a cold cathode. On the cathode member 3, three electron emission portions 1 and three auxiliary electron emission portions 2 are formed. Above the cathode member 3, the control electrode 4 is disposed. The control electrode 4 has holes 5 in positions facing the electron emission portions 1. In FIG. 1, directly above the electron emission portions 1, the holes 5 of the control electrode 4 are placed, respectively. Each central axis 1a of the electron emission portion 1 coincides with each central axis 5a of the hole 5. In this positional relationship, since an electron beam emitted from the electron emission portion 1 passes through the center of the hole 5 of the control electrode 4, the focus characteristics can be optimized.

In this embodiment, when electron emission portions 1 being used for constituting a cold cathode are deteriorated after they are operated for a long time, resulting in the reduction of the amount of emission current, the electron emission portions 1 are replaced with the auxiliary electron emission portions 2 to be operated. At this time, if the electron emission portions 2 merely are switched to be operated in place of the electron emission portions 1, the position of the holes 5 of the control electrode 4 are displaced from the respective positions of the electron emission portions. Therefore, in this embodiment, the electron emission portions to be operated are replaced by moving the cathode member 3. Note here that the number of sets of the auxiliary electron emission portions 2 is not limited to one as shown in FIG. 1. A configuration may be provided in which two or more sets of auxiliary electron emission portions 2 are disposed for sequentially changing the electron emission portions to be operated.

By moving the cathode member 3 to replace the electron emission portions in this way, it is possible to align the positions of the auxiliary electron emission portions 2 with the holes 5 of the control electrode 4 with high accuracy. Therefore, the electron emission portions to be operated can be replaced without displacement of the electron beams to be emitted, realizing a longer life.

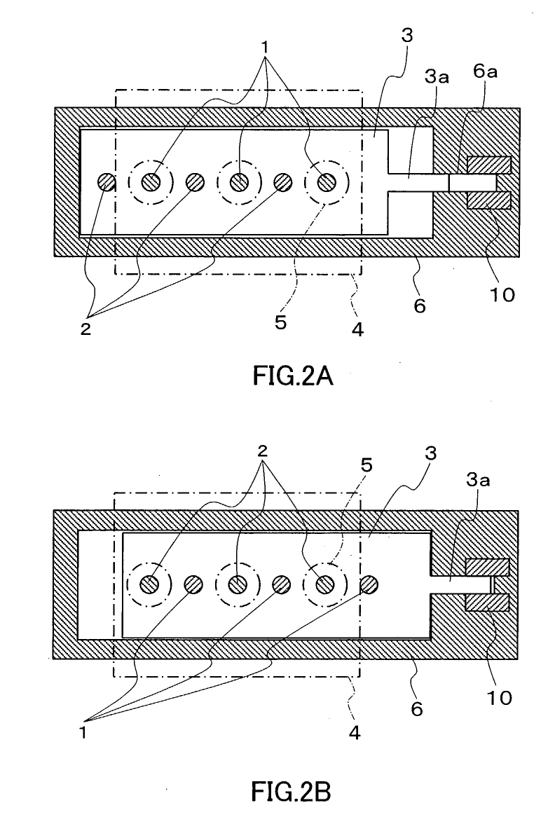

Next, an example of a moving mechanism for the cathode member 3 will be explained with reference to FIGS. 2A and 2B. FIGS. 2A and 2B are views of the cathode member 3 and the control electrode 4 seen from the upper side. However, for easy understanding, the control electrode 4 is shown by an alternate long and short dashed line. The cathode member 3 is held in a cathode frame 6 so as to secure the positioning accuracy and to facilitate the movement of the cathode member 3. At the right end of the cathode frame 6, a guide groove 6a is provided and a protruding portion 3a provided at the right end of the cathode member 3 is engaged with the guide groove 6a. At both sides of the guide groove 6a, electromagnets 10 are disposed as a component of the moving mechanism, thus enabling the moving force to be effected on the protruding portion 3a of the cathode member 3.

FIG. 2A shows a state in which the electron emission portions 1 are placed directly below the holes 5 of the control electrode 4, and electron beams are emitted from the electron emission portions 1. In this state, the electromagnet 10 is in an OFF state. The left end face of the cathode member 3 is in contact with the inner surface of the left end of the cathode frame 6, thereby securing the positioning accuracy.

FIG. 2B shows a state after a cathode member 3 was slid linearly by turning the electromagnet 10 ON, so that the auxiliary electron emission portions 2 are placed directly under the holes 5 of the control electrode 4. In this state, the right end face of the cathode member 3 is in contact with the inner surface of the right end of the cathode frame 6, thereby ensuring the positioning accuracy.

As mentioned above, since the positioning of the cathode member 3 can be carried out with high accuracy, it is possible to replace the electron emission portions and operate without the axis misalignment.

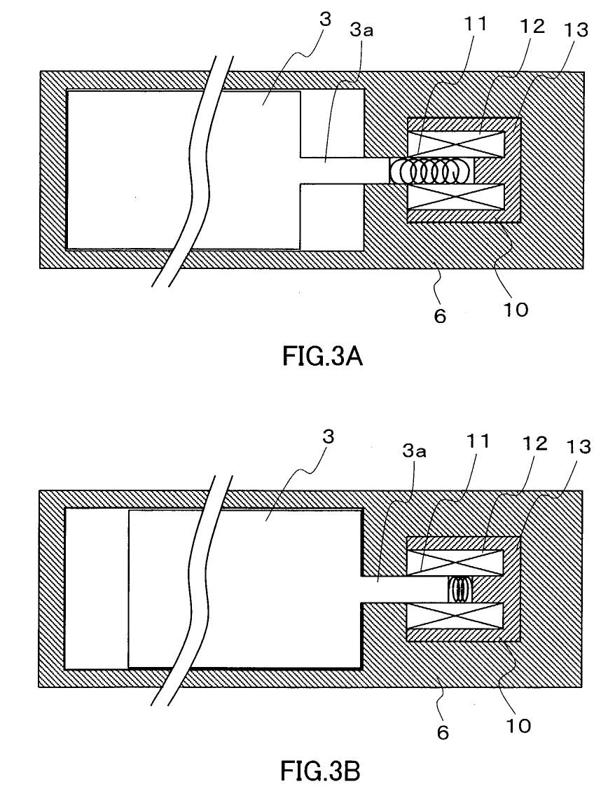

Next, the detail of a configuration for moving and positioning the cathode member 3 will be explained with reference to FIGS. 3A and 3B. FIGS. 3A and 3B are enlarged views showing a more specific structure of the portion in which the electromagnets 10 are disposed in FIGS. 2A and 2B. The electromagnet 10 includes a coil 12, an iron core 13 and a spring 11. Note here that the electron emission portions 1, the auxiliary electron emission portions 2 and the control electrode 4, etc. are not shown.

FIG. 3A shows a state in which the electromagnet 10 is turned OFF and the cathode member 3 is pressed toward the left side by the spring 11. In this state, the left end of the cathode member 3 is pressed onto the inner surface of the left end of the cathode frame 6. FIG. 3B shows a state in which the electromagnet is turned ON. The coil 12 is supplied with an electric current and the protruding portion 3a of the cathode member 3 is attracted by the iron core 13. In this state, the cathode member 3 is pressed onto the inner surface of the right end of the cathode frame 6.

As mentioned above, by turning the electromagnet 10 ON/OFF, it is possible to slide the cathode member 3. Furthermore, the cathode member 3 is positioned by the inner surface of the cathode frame 6 so as to secure the positional accuracy. Thus, it is possible to move the electron emission portions with high accuracy.

Furthermore, in order to maintain the state in which the cathode member 3 is shifted to the right side, it is necessary to maintain the electromagnet 10 always the ON state. Therefore, the electron magnet 10 is always supplied with electric current. Alternately, a mechanism for securing the position of the cathode member 3 may be added for preventing the cathode member 3 from being shifted to the opposite direction.

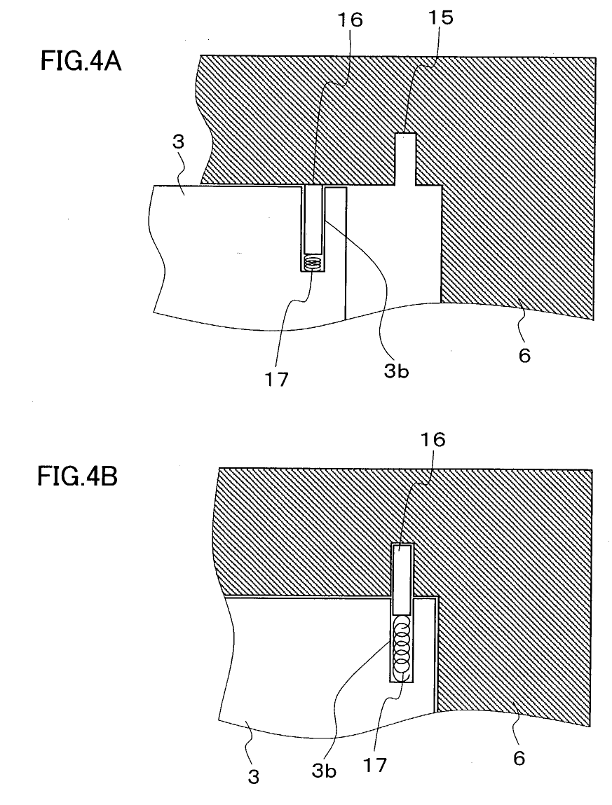

Next, an example of such a mechanism for securing the position for preventing backward movement will be explained with reference to FIGS. 4A and 4B. FIGS. 4A and 4B are partially enlarged views showing a part of the cathode member 3 and the cathode frame 6. FIG. 4A shows the state in which the cathode member 3 is positioned at the left side. As shown in FIG. 4A, the cathode member 3 is provided with a groove 3b in which a spring 17 and a latch 16 are disposed. The cathode frame 6 is provided with a groove 15.

As explained with reference to FIG. 3B, when the electromagnet 10 is turned ON from the state shown in FIG. 4A, the cathode member 3 moves to the right side. When the cathode member 3 moves to the right side and the position of the latch 16 coincides with the position of the groove 15, the latch 16 projects into the groove 15 by the force of the spring 17. According to this structure, since the latch 16 is urged strongly toward the cathode frame 6 by the force of the spring 17, once the latch 16 is moved into the groove 15, the latch 16 does not return to the original position. By using the latch 16, it is possible to prevent the cathode member 3 from returning backward when the electromagnet 10 is turned OFF. Furthermore, the positioning can be determined by the latch 16 and the wall face of the respective grooves, and the positioning accuracy can be secured easily. In this way, by using the latch 16 and the spring 17, it is possible to secure the accuracy of positioning the cathode member 3 and to prevent the cathode member 3 from returning backward without keeping the electromagnet 10 ON.

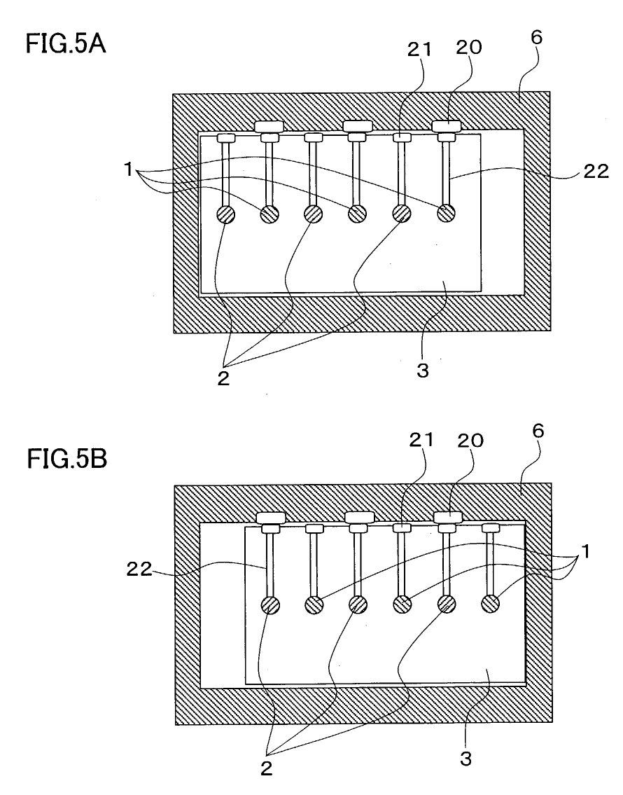

Next, an example of a structure for switching the electric power feeding from the electron emission portions 1 to the auxiliary emission portions 2 when the cathode member 3 is moved will be explained with reference to FIGS. 5A and 5B. As shown in FIG. 5A, the cathode frame 6 is provided with the terminal pads 20 for feeding electric power. The side face of the cathode member 3 is provided with terminal pads 21 to which the electron emission portions 1 and the auxiliary electron emission portions 2 are connected via extracting wires, respectively. FIG. 5A shows a state in which the cathode member 3 is placed at the left side, and the terminal pad 20 of the cathode frame 6 and the terminal pad 21 connected to the electron emission portion 1 are electrically connected. In this state, as shown in FIG. 2A, the electron emission portions 1 are positioned directly below the holes 5 of the control electrode 4, so that electron beams pass through and are emitted from the holes 5.

FIG. 5B shows a state in which the cathode member 3 is shifted to the right side. At this time, the connection pads 21 provided on the cathode member 3 also are shifted. In this state, the terminal pads 20 provided for the cathode frame 6 are connected electrically to terminal pads 21 of the auxiliary electron emission portion 2. Furthermore, the auxiliary electron emission portions 2 are positioned directly below the holes 5 of the control electrode 4, so that electron beams pass through and are emitted from the holes 5.

As mentioned above, by providing the terminal pad 21 on the side surface of the cathode member 3, when the cathode member 3 is moved respective electron emission portions can be supplied with electric power, thus making it easy to replace electron emission portions.

As mentioned above, according to the cold cathode of the present invention, it is possible to replace the electron emission portion without the axis misalignment of electron beam by moving the electron emission portion with high accuracy. Therefore, the life of the cathode is prolonged while maintaining the focus characteristics of electron beams. As a result, it is possible to realize a cold cathode with high brightness, high resolution and a long life.

Note here that in this embodiment, electromagnets are used in order to move the cathode member 3, but the present invention is not necessarily limited to this configuration. Any methods using magnetic force may be employed to move the cathode member. For example, a configuration in which a permanent magnet is provided on the cathode member and the cathode member is moved by the magnetic field applied from the outside may be employed.

Furthermore, although this embodiment achieves the function for preventing the cathode member from moving backward by using a latch, the present invention is not necessarily limited to this configuration. Any structures may be used as long as they have a function capable of securing and fixing the position.

Furthermore, although in this embodiment, the cathode member is moved by using a spring and an electromagnet, any structures other than an electromagnet may be used as long as they can move the cathode member by a predetermined operation from the outside.

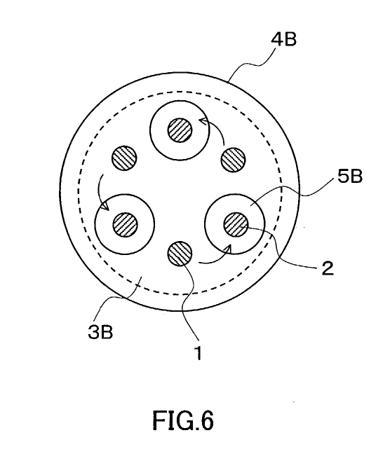

Furthermore, although in this embodiment, the electron emission portions are arranged in series, the arrangement is not necessarily limited to this. For example, as shown in FIG. 6, the electron emission portions 1 and the auxiliary electron emission portions 2 may be arranged on the circumference of a circular shaped cathode member 3B. In this case, the electron emission portions 1 and 2 are moved by rotating the cathode member 3B aligning with the holes 5B of the control electrode 4B, instead of moving electron emission portions linearly.

(Second Embodiment)

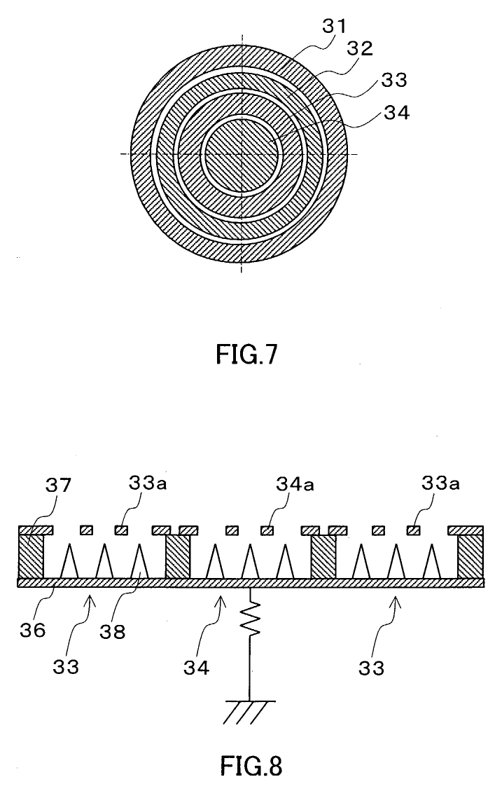

A structure of a cold cathode according to the second embodiment of the present invention will be explained with reference to FIGS. 7 and 8. In this embodiment, the cold cathode is formed in a circular shape or a ring shape. That is, as shown in FIG. 7, the ring-shaped cathode members 31-33 are disposed concentrically around a circular-shaped cathode member 34. In this embodiment, the cathode member to be operated is replaced by simply changing the cathode member to be supplied with power instead of moving the cathode member. At the initial time of operation, electron beams may be taken out from the cathode member 34. When the electron emission portions provided on the cathode member 34 deteriorate after the passage of operating time, and the amount of the emitted electrons is decreased, plural sets of electron emission portions, that is, the cathode members 31-33 are switched one by one to be operated, thereby realizing the long life of the cathode.

With this structure, since respective cathode members 31-34 are disposed concentrically, even if the cathode member to be operated is changed, the central position thereof is not changed. Furthermore, if the electron emission portions provided on the respective cathode members 31-34 are made to have the same area, the amount of electron beams hardly is changed when a cathode member is changed. Therefore, when a control electrode (not shown) having holes is disposed above the cathode member, so as to control electron beams, the control property thereof, that is the focus property for the electron beams, is not changed. Thus, since the cathode member is changed without the axis misalignment of an electron beam, it is possible to prolong the life of the cathode while maintaining the focus property of the electron beams.

A detailed configuration of the circular-shaped or ring-shaped cold cathode as mentioned above will be explained with reference to FIG. 8. However, FIG. 8 shows only a part of the cathode members 33 and 34 of FIG. 7.

In FIG. 8, reference numeral 36 denotes a cathode electrode. On the cathode electrode 36, an insulating layer 37 is deposited. On a part area of the cathode electrode 36 defined by the insulating layer 37, emitters 38 having a sharp tip portion are formed. Above the, insulating layer 37, extracting electrodes (control electrodes) 33a and 34a are formed, respectively. The insulating layer 37 and extracting electrodes 33a and 34a define a single or a plurality of space(s), and in the spaces, the emitters 38 are disposed.

The cathode electrode 36 is common to the cathode members 33 and 34. However, the extracting electrodes 33a and 34a are separated for each cathode member 33 and 34. That is, the extracting electrode 34a of FIG. 8 is a component of the cathode member 34 of FIG. 7; and the extracting electrode 33a of FIG. 8 is a component of the cathode member 33 of FIG. 7.

In order to change the cathode members 33 and 34 to be operated, voltage applied to the extracting electrode 33a and 34a may be changed. Thus, it is advantageous that operation and replacement of the cathode member can be carried out simply.

Thus, with the configuration in which the extracting electrodes are separated, the cathode can be formed by a simple process and operation and replacement can be carried out easily.

Note here, although this embodiment employs a configuration in which extracting electrodes are separated, the configuration is not necessarily limited to this, and a configuration in which the cathode electrode 36 is separated may be employed.

(Third Embodiment)

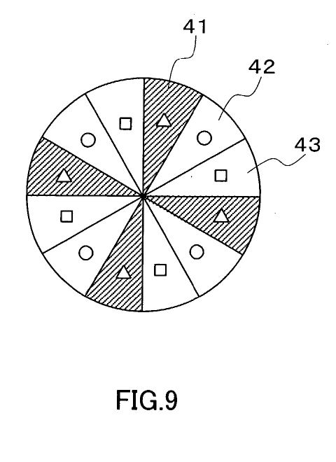

A structure of an electron emission portion used for a cold cathode according to the third embodiment of the present invention will be explained with reference to FIG. 9. A basic operation is similar to that of the second embodiment and a divided shape of the electron emission portions is different from that of the second embodiment. Therefore the divided shape will be explained.

FIG. 9 shows another example of the divided shape that does not cause the axis misalignment of an electron beam when an electron emission portion to be operated is replaced. In this shape, respective region boundaries of the electron emission portions 41, 42 and 43 radially extend from the center toward the outer circumference. Marks Δ, ◯ and □ show the electron emission portions 41, 42 and 43, respectively. Theses shapes are axially symmetrical, and even if the electron emission portions are replaced, the shape of the cathode is not changed and actually only an operating region is rotated.

Therefore, even if a control electrode (not shown) having holes is disposed above the electron emission portions to control electron beams, the control property is not changed as the electron emission portions are replaced, so that the focus property of the electron beams is not changed.

As mentioned above, since an electron emission portion can be replaced without the axis misalignment of an electron beam, the life of the cold cathode can be prolonged while maintaining the focus property of electron beams.

(Fourth Embodiment)

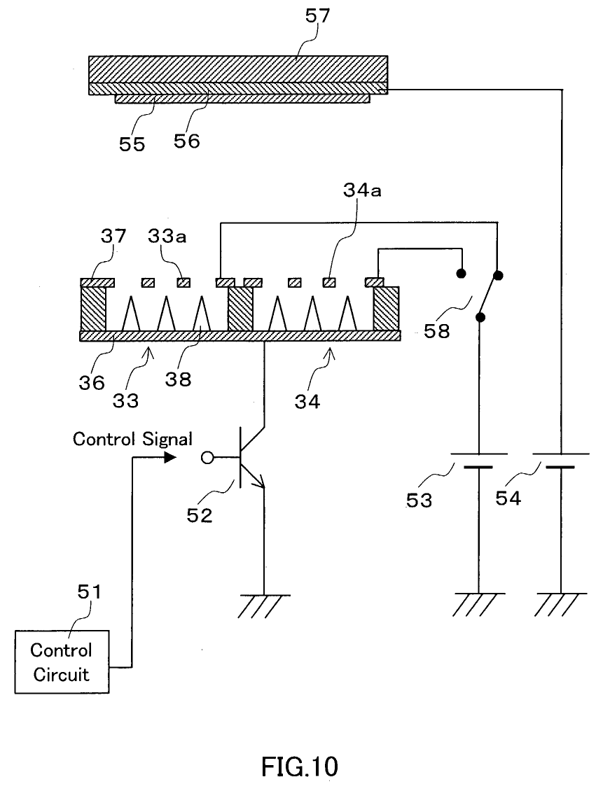

A method for operating the cold cathode according to the fourth embodiment of the present invention will be explained with reference to FIG. 10. FIG. 10 shows a cold cathode having electron emission portions 33 and 34, which are disposed as divided regions such as in the second or third embodiments and are used by selecting with the use of a switch 58.

As shown in FIG. 10, a cathode structure including the electron emission portions 33 and 34 is similar to that shown in FIG. 8. On the side above the emitters 38 and the extracting electrodes 33a and 34a, a substrate 57 provided with an anode electrode 56 is disposed. On the anode electrode 56, a phosphor 55 is formed facing the emitters 38.

To the anode electrode 56, an anode power supply 54 is connected. The anode power supply 54 works for accelerating electrons emitted from the emitter 38 toward the side of the anode electrode 56. To the extracting electrodes 33a and 34a, an extracting power supply 53 is connected via a switch 58. When voltage of the extracting power supply 53 is increased, electrons are emitted from the emitter 38 at a predetermined threshold voltage. The emitted electrons are accelerated by an electric field from the anode electrode 56 and collide with a phosphor 55, so that the phosphor emits light.

The operation of changing the electron emission portions 33 and 34 is carried out by the switch 58. That is, with the switch 58, voltage from the extracting power supply 53 is supplied selectively to either one of the electrode 33a and 34a.

Furthermore, according to this embodiment, a current control device 52 is connected to the cathode electrode 36 so as to control the amount of electrons emitted from the emitter 38. A control signal input from the control circuit 51 into the current control device 52 controls the amount of electric current flowing through the current control device 52, thus controlling the amount of electrons emitted from the emitter 38. As the current control device 52, for example, an FET is used. By using the FET in a saturation region, it is possible to obtain the stable current with extremely little fluctuation. By keeping the current constant with the current control device 52 in the range lower than the emission ability value determined by the extracting voltage 33a and 34a, it is possible to obtain a stable current even when being deteriorated over time.

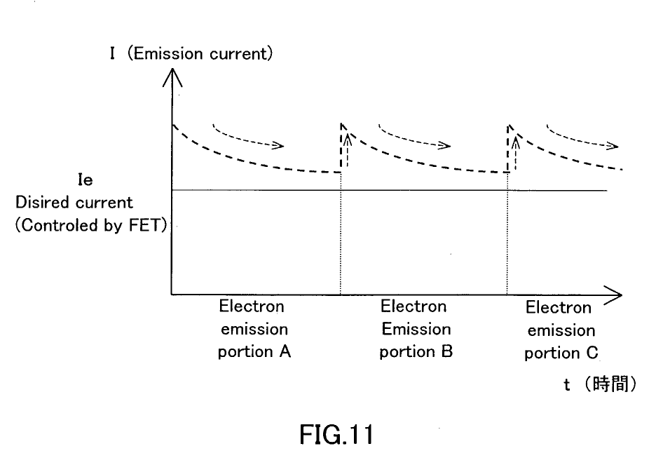

This operation is shown in FIG. 11. At the initial time of the emission, an electron emission portion A is operated and the electron control device controls so that the emission current is constant at le in the range lower than the emission ability (shown by a broken curve in FIG. 11) determined by the extracting voltage. When the device deteriorates over time and the emission ability is lowered, the operation of the electron emission portion A is replaced with the operation of the electron emission portion B. Thereby, the emission ability is increased as shown. Furthermore, as time passes, also the device of the electron emission portion B deteriorates and so the emission ability thereof is lowered. Then, the operation of the electron emission portion B is replaced with the operation of the electron emission portion C.

As mentioned above, in accordance with the deterioration of the electron emission portion, by changing the electron emission portion to be used, it is possible to maintain the emission ability at a desired value range or more, realizing the long life. Furthermore, by connecting the current control device so as to control the current value, stable emission current can be provided.

As mentioned above, by changing a plurality of electron emission portions, it becomes possible to obtain an emission current having a long life and stability.

(Fifth Embodiment)

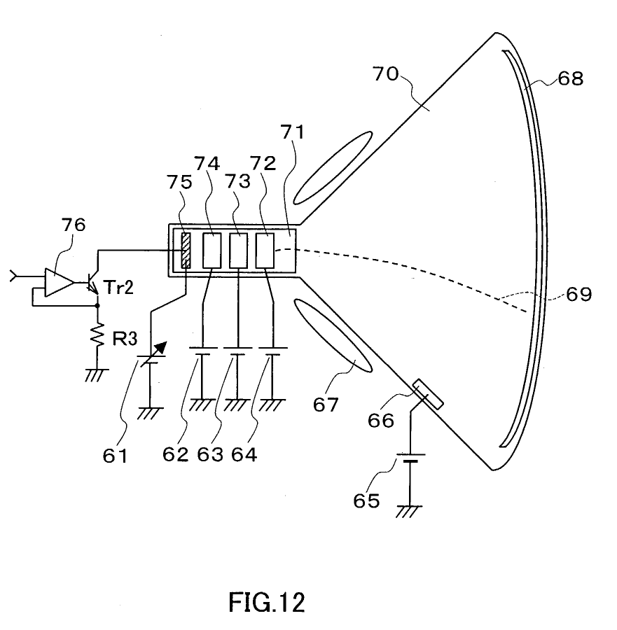

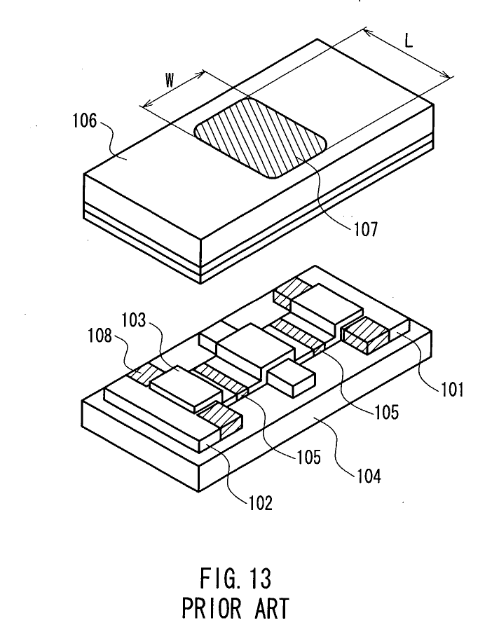

FIG. 12 is a view showing a picture tube (CRT) according to the fifth embodiment that is one example of an image display apparatus using a cold cathode of the present invention.

In this picture tube, a cold cathode 75 having the configurations explained in any one of the above-mentioned embodiments is disposed inside a cathode ray tube 70. Electrons emitted from the cold cathode 75 are converged and accelerated by a first electrode 74, a second electrode 73 and a third electrode 72 constituting an electron gun 71 disposed inside the cathode ray tube 70 to form an electron beam 69. The electron beam 69 is deflected by a deflection coil 67 and collides with the phosphor 68 at a predetermined position. Electron beam current flows into an anode power supply 65 via an anode terminal 66 connected to the phosphor 68 (connection state thereof is not shown) To the cold cathode 75, the first electrode 74, the second electrode 73 and the third electrode 72, positive voltages are applied from the power supplies 61, 62, 63 and 64, respectively. Picture signals are input to the cold cathode device 75 through a circuit including an operational amplifier 76, a transistor Tr2 and a resistor R3 shown in FIG. 12.

By applying the cold cathode 75 using an electric field emission device to a picture tube in this way, it is possible to display an image stably for a long time. Furthermore, since it is possible to change a cathode without an axis misalignment of an electron beam, high brightness, high resolution and a long life can be realized. Furthermore, by connecting a current control device, it is possible to obtain stable electron beams with high accuracy, and thus provide a high quality image.

Note here, although in this embodiment, an example in which a CRT is manufactured including the cold cathode 75 in an electron gun 71 was explained, the application example of the cold cathode of the present invention is not limited to this, and the cold cathode can be applied to an electron beam device, a light source, or a discharge tube. Furthermore, it is possible to construct picture tube system using a CRT tube in which the cold cathode of the present invention is mounted. In the example of such applications, it is possible to achieve high brightness, high resolution and long life, that is, the features of the present invention.

As mentioned above, according to the cold cathode of the present invention, since a cathode is replaced by moving the cathode with high accuracy by moving the cathode with high accuracy without the axis misalignment of an electron beam, the life of the cathode can be prolonged while maintaining the focus property of the electron beam. Therefore, it is possible to achieve an electron beam enabling the high brightness, high resolution and a long life.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

What is claimed is:

1. A method for operating a cold cathode having at least one electron emission portion and a control electrode for controlling an emission of electrons, in which an electron beam is extracted out of the cold cathode by applying operating voltages to the electron emission portion and the control electrode, respectively, wherein
at least one auxiliary electron emission portion is provided other than the electron emission portion positioned at an operating position for emitting electrons, and
in order to replace the electron emission portion to be operated, the electron emission portions are moved so that the auxiliary electron emission portion is positioned at the operating position.

2. The method for operating a cold cathode according to claim 1, wherein
plural sets of the electron emission portions are disposed on a cathode member,
the control electrode has through holes which are capable of facing selectively one of the sets of the electron emission portions, so that the electron beams are extracted through the through holes, and
in order to replace the set of the electron emission portions to be operated, the cathode member is moved so as to change the relative positional relationship with the control electrode, whereby a selected auxiliary set of the electron emission portions is positioned to face the through holes.

3. The method for operating a cold cathode according to claim 2, wherein
each of the electron emission portions and the through holes have a circular shape, and
the cathode member is moved so as to adjust the relative positional relationship with the control electrode, whereby the centers of the electron emission portions of the selected auxiliary set are allowed to coincide with the center axes of the through holes.

4. The method for operating a cold cathode according to claim 1, wherein the electron emission portions are moved by a magnetic force.

5. The method for operating a cold cathode according to claim 2, wherein the cathode member is moved by a magnetic force.

6. The method for operating the cold cathode according to claim 1, wherein the electron emission portions are retained at the operating position by using a mechanism for preventing movement of the electron emission portions backward from the operating position.

7. The method for operating the cold cathode according to claim 2, wherein the electron emission portions are retained at the operating position by using a mechanism for preventing movement of the cathode member backward from the operating position.

8. A method for operating a cold cathode having at least one electron emission portion and a control electrode for controlling an emission of electrons, in which an electron beam is extracted out of the cold cathode by applying operating voltages to the electron emission portion and the control electrode, respectively, wherein
a plurality of the electron emission portions are disposed axially symmetrically with respect to a center of an operating position for emitting electrons, and
in order to replace the electron emission portion to be operated, the electron emission portion to be supplied with the operating voltage is changed to the replacing electron emission portion.

9. The method for operating a cold cathode according to claim 8, wherein the electron emission portions are provided in shapes obtained by dividing a disk-shaped area concentrically or radially.

10. A cold cathode comprising: at least one electron emission portion; and a control electrode for controlling an emission of electrons, in which an electron beam is extracted out of the cold cathode by applying operating voltages to the electron emission portion and the control electrode, respectively, wherein
at least one auxiliary electron emission portion is provided other than the electron emission portion positioned at an operating position for emitting electrons, and
a replacing mechanism is provided in order to replace the electron emission portion to be operated, the replacing mechanism being capable of moving the electron emission portions so that the auxiliary electron emission portion is positioned at the operating position.

11. A cold cathode according to claim 10, wherein
plural sets of the electron emission portions are disposed on a cathode member,
the control electrode has through holes which are capable of facing selectively one of the sets of the electron emission portions, so that the electron beams are extracted through the through holes, and
the replacing mechanism is provided in order to replace the set of the electron emission portions to be operated, the replacing mechanism being capable of moving the cathode member so as to change the relative positional relationship with the control electrode, whereby a selected auxiliary set of the electron emission portions is positioned to face the through holes.

12. The cold cathode according to claim 11, wherein
each of the electron emission portions and the through holes have a circular shape, and
the cathode member is moved so as to adjust the relative positional relationship with the control electrode, whereby the centers of the electron emission portions of the selected auxiliary set are allowed to coincide with the center axes of the through holes.

13. The cold cathode according to claim 10, wherein the replacing mechanism moves the electron emission portions by a magnetic force.

14. The cold cathode according to claim 11, wherein the replacing mechanism moves the cathode member by a magnetic force.

15. The cold cathode according to claim 10, further comprising a mechanism for preventing movement of the electron emission portions backward from the operating position so that the electron emission portions are retained at the operating position.

16. The cold cathode according to claim 11, further comprising a mechanism for preventing movement of the cathode member backward from the operating position so that the electron emission portions are retained at the operating position.

17. A cold cathode comprising: at least one electron emission portion; and a control electrode for controlling an emission of electrons, in which an electron beam is extracted out of the cold cathode by applying operating voltages to the electron emission portion and the control electrode, respectively, wherein
a plurality of the electron emission portions are disposed axially symmetrically with respect to a center of an operating position for emitting electrons, and
a replacing mechanism is provided in order to replace the electron emission portion to be operated, the replacing mechanism being capable of changing the electron emission portion to be supplied with the operating voltage to the replacing electron emission portion.

18. The cold cathode according to claim 17, wherein the electron emission portions are provided in shapes which are obtained by dividing a disk-shaped area concentrically or radially.

19. The cold cathode according to claim 10, further comprising a current control device connected to an emitter constituting the electron emission portion.
